(19) United States
(12) Patent Application Publication
(10) Pub. No.: US 2007/0102172 A1
(43) Pub. Date: May 10, 2007

(54) Rotating scraper

(76) Inventor: James Meidinger, Wishek, ND (US)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/524,969

(22) Filed: Sep. 21, 2006

Related U.S. Application Data
(60) Provisional application No. 60/734,824, filed on Nov. 9, 2005.

(51) Int. Cl. A01B 31/00

(52) U.S. Cl. 172/690

(57) ABSTRACT

A scraper that is mounted to a tool bar of a farm implement having rotating disk for tilling soil includes a support that is mounted to the tool bar and a shaft extending from the support and having a central axis. A scraper blade is rotatably attached to the shaft and wherein the scraper blade comprises a perimeter and wherein the perimeter of the scraper blade rotatably engages a side surface of the rotating disk prevents soil from accumulating on the side surface and to prevent debris from accumulating between the side surface and the scraper blade.

### CROSS REFERENCE TO RELATED APPLICATION(S)

This application claims the benefit of U.S. Provisional Application Ser. No. 60/734,824 filed on Nov. 9, 2005 which is incorporated by reference herein in its entirety.

### BACKGROUND OF THE INVENTION

The present invention relates to a scraper for a farm implement. More particularly, the present invention relates to a scraper having a rotating blade that is attached to a farm implement.

There are many types of farm implements that are used to till soil in preparation for seeding or planting. One such farm implement is a tandem disk.

A typical configuration of a tandem disk includes a front gang of disks proximate a front end of the tandem and a back gang of disks proximate a back end of the tandem disk. The front gang of disks are configured generally in a V-shaped pattern and the back gang of disks are configured in the inverse V-shaped pattern.

As the tandem disk is pulled through the field by a tractor, or other prime mover, the front gang of disks mulches debris on the surface and also tills the soil by forcing the soil transversely away from a plane in the direction of travel of the tractor and the tandem disk. The back gang of disks also mulch debris and tills the soil by forcing the soil transversely towards the plane in the direction of travel of the tractor and the tandem disk.

However, when the soil is moist or wet while being tilled with a tandem disk, the soil has a tendency of accumulating on a concave surface of the disks. As soil accumulates on the concave surface of the disk, the disk looses its effectiveness in penetrating the soil and mulching the debris.

To prevent soil from accumulating on the concave surface of the disk, static, rigid scrapers are typically positioned near the concave surface of the disk. However, the static, rigid scrapers have a tendency of bending or rotating away from the concave surface of the disk and thereby allow the wet soil to accumulate on the concave surface of the disk which adversely affects the ability of the disk to till the soil and mulch the debris. Further, the debris has a tendency of collecting between the static scraper and the disk which may prevent the disk from rotating.

### SUMMARY OF THE INVENTION

The present invention includes a scraper for mounting to a tool bar of a farm implement having at least one rotating disk for tilling soil. The scraper includes a support mounted to the tool bar and a shaft extending from the support where the shaft has a central axis. A scraper blade is rotatably attached to the shaft and the scraper blade comprises a perimeter that rotatably engages a side surface of the rotating disk to prevent soil from accumulating on the side surface and prevents debris from accumulating between the side surface and the scraper blade.

The present invention also includes a farm implement having at least one rotating disk for tilling soil and a tool bar proximate the at least one rotating disk. The farm implement also includes at least one scraper attached to the tool bar where the scraper includes a support mounted to the tool bar and a shaft extending from the support where the shaft has a central axis. A scraper blade is rotatably attached to the shaft and wherein the scraper blade has a perimeter that rotatably engages a side surface of the rotating disk to prevent soil from accumulating on the side surface and prevents debris from accumulating between the side surface and the scraper blade.

### BRIEF DESCRIPTION OF THE DRAWINGS

FIG. 1 is a side view of a portion of a gang of disks having a rotating scraper engaging a concave surface of each disk.

FIG. 2 is an exploded view of the rotating scraper of the present invention.

FIG. 3 is a sectional view of the rotating scraper of the present invention.

### DETAILED DESCRIPTION OF ILLUSTRATIVE EMBODIMENTS

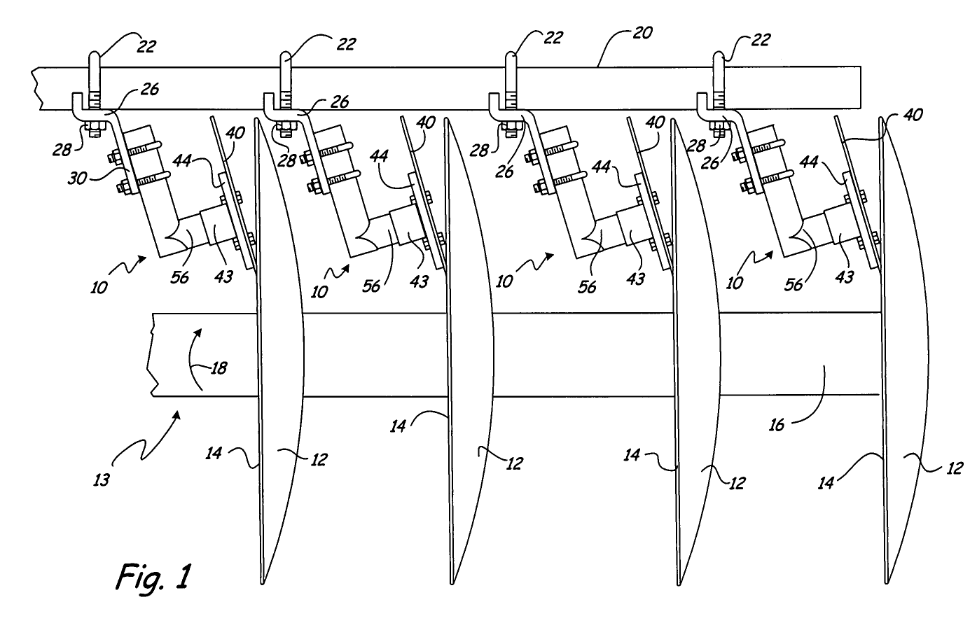

A rotating scraper for a disk blade attached to a farm implement is generally illustrated in FIG. 1 at 10. Each rotating scraper 10 includes a scraper blade 40 that rotatably engages a side surface 14 of a disk blade 12 to prevent soil and/or debris from accumulating on the disk blade 12. Typically, the side surface 14 of the disk blade 12 is concave, however the side surface 14 could also be substantially flat or convex.

Typically, the rotating scraper 10 is attached to a tool bar 20 of a tandem disk where the disk blades 12 are secured to a shaft 16 to form a gang 13 of a tandem disk. The disks 12 rotate along with the shaft 16 in the rotational direction of arrow 18. While the rotating scraper 10 is typically utilized with a tandem disk, the rotating scraper 10 can also be utilized with disks on other agricultural equipment.

Typically, the disk blades 12 have a circular perimeter 11 that penetrates the ground between about one inch and about six inches depending upon the farm implement being utilized. The scraper blade 40 typically has a circular perimeter 41 that engages the side surface 14 of disk blade 12 in an arcuate engagement extending between two points on the perimeter 11 on the side surface 14 of the disk blade 12 where a lowest contact point of the perimeter 41 of the scraper blade 40 with the side surface 14 of the disk blade 12 is beneath the deepest penetration depth of the disk blade 12, thereby preventing soil from accumulating on the side surface 14 or debris from accumulating between the side surface 14 and the scraper blade 40.

The rotating scraper 10 can be utilized to prevent soil from accumulating on a surface ranging from a concave configuration as illustrated in FIG. 1, to a substantially flat configuration to convex configuration depending upon the angle of the support utilized to attach the scraper blade 40 to the tool bar 20. For a flat vertical surface, the support utilized would be configured to position the scraper blade 40 in a substantially vertical position. For a convex surface the support would be configured to position the scraper blade 40 into engagement with the side surface 14 of the disk blade 12 along one side of the disk blade 12 where the perimeter of the scraper blade 40 engages the perimeter of the side surface 14 of the disk blade 12. In any configuration of the support, the rotating scraper 10 would include a shaft attached to the support where the shaft attaches to the scraper blade 40 in a manner that allows the scraper blade 14 to rotate about the axis of the shaft.

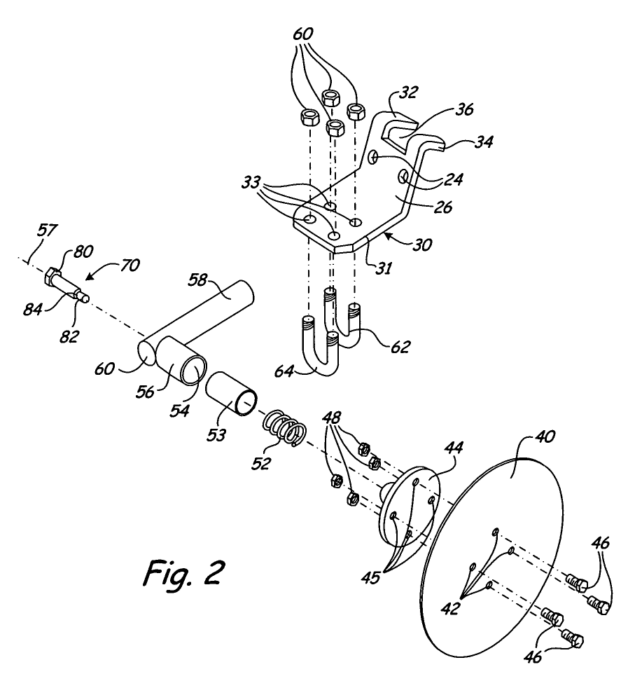

Referring to FIG. 1 and 2, each of the rotating scrapers 10 is secured to the tool bar 20, or other frame member, by positioning a U-shaped bolt 22 over the tool bar 20 and through apertures 24 in a substantially flat surface 26 of a mounting bracket 30. The U-shaped bolt 22 is secured to the mounting bracket 30 with a threaded engagement of threaded ends with nuts 28 to prevent the lateral movement of the mounting bracket 30 along a length of the tool bar 20.

The mounting bracket 30 also includes left and right tabs 32 and 34, respectively, that define a channel 36 having a width sufficient to position the left and right tabs 32 and 34 on opposite sides of a substantially square or rectangular cross-sectional tool bar 20. The engagement of the tabs 32, 34 with the sides of the tool bar 20 prevent rotational movement of the mounting bracket with respect to the tool bar 20.

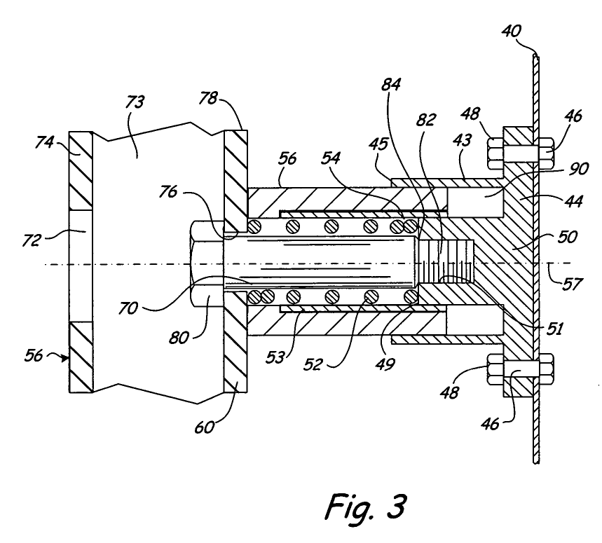

Referring to FIGS. 2 and 3, the rotating scraper blade 40 is attached to a hub 44 with a plurality of bolts 46. The bolts 46 are positioned through apertures 42 in the rotating scraper blade 40 and apertures 45 in the hub 44, and are threadably engaged by the nuts 48 to removeably secure the rotating scraper blade 40 to the hub 44.

The hub 44 includes a stub shaft 50 that is positioned within a bore 54 of a housing 56 that is attached to a distal end 60 of a shank 58, preferably with a weld. Prior to positioning the stub shaft 50 into the bore 54, a bushing 53 is positioned into the bore to prevent erosion of the housing 56 over time with use. A compression spring 52 is positioned within the bore 54 to bias the rotating scraper blade 40 into an engagement with the surface 14 of the disk blade 12.

The rotating scraper blade 40 and the hub 44 are rotatably secured to the housing 56 by inserting a bolt 70 through an aperture 72 in an outer wall 74 of the shank 58 and an aperture 76 in an inner wall 78 of the shank 58 such that a threaded end of the bolt 70 threadably engages a threaded bore in the stub shaft 50. A head 80 of the bolt 70 is positioned through the aperture 72 in the outer wall 74 where the head 80 of the bolt 70 has a diameter that is greater than the diameter of the aperture 76 in the inner wall 78 of the shank 58 such that the head 80 engages the shank 58 to retain the bolt 70 within the shank 58.

The aperture 72 in the outer surface 74 of the shank 58 is typically of a size sufficient to allow a socket to be positioned through the aperture 72 to engage the head 80 to rotate the bolt 70 with a rachet. As the bolt 70 is rotated, a threaded end 82 of the bolt 20 engages a threaded bore 51 in the stub shaft 50 until a shoulder 84 on the bolt 30 frictionally engages an end 49 surface of the stub shaft 50 which secures the bolt 20 to the stub shaft 50.

The frictional engagement of the shoulder 84 to the end 49 of the stub shaft 50 allows the bolt 20 to travel laterally along an axis 57 of the bolt 70 and the housing 56 when the disk 40 engages debris or soil on the surface 14 of the cutting disk 12. The frictional engagement of the shoulder 84 with the end 49 of the stub 50 shaft also allows the bolt 70 to rotate about the axis 57 as the disk 40 rotates depending upon the location of the debris or soil on the surface of the disk.

The shank 58 is preferably a pipe having a continuous circular wall defining a through bore 73. However the shank 58 may also be constructed from a square or rectangular cross-sectional tube as well as a solid material such as steel.

The shank 58 is secured to an angled portion 31 of the mounting bracket 30 with top and bottom U-shaped bolts 62, 64 positioned about the shank 58 and through apertures 33 in the slanted portion 31 of the mounting bracket 30. With the U-shaped bolt 62 and 64 positioned about the shank 58 and through the apertures 33, lock washers (not shown) are typically positioned about the threaded ends of the U-shaped bolts 62 and 64 and nuts 68 are threadably engaged with the threaded ends of the U-shaped bolts 62 and 64 to frictionally secure the shank 58 in a selected position.

The hub 44 also includes a dust shield 43 that forms a channel 90 with the stub shaft 50 that allows the hub 44 to move along the axis 57 when the scraper blade 40 engages accumulated dirt and debris on the side surface 14 of the disk blade 12. A distal end 45 of the dust shield 43 extends beyond the end 49 of the stub shaft 50 and extends over distal end of the housing 56 to prevent dust, soil and debris from entering the through bore 54 in the housing 56 that contains the compression spring 52, and thereby increases the efficiency of the rotating scraper 10.

In operation, rotation of the disk blade 12 in direction of arrows 18 causes the disk blade 40 to rotate about the stub shaft 50 either clockwise or counter-clockwise about the axis 57 in a rotation of least resistance. Rotation of the scraper blade 40 as the disk blade 12 rotates in direction of arrows 18, prevents soil from accumulating on the side surface 14 of the disk blade 12.

Further, the bias of the compression spring 52 maintains the rotating scraper blade 40 in contact with the side surface 14 of a disk blade 12 to ensure that soil does not accumulate on the side surface 14 of the disk blade 12. It has been found that the rotating scraper system 10 of the present invention provides a much more efficient system for maintaining the side surface 14 of the disk blade 12 free of soil.

The rotating scraper blade 40 also eliminates the issue of debris collecting between the scraper blade 40 and the side surface 14 of a disk blade 12. As debris contacts the disk blade 12 and the scraper blade 40, the scraper blade 40 rotates to prevent the debris from wedging between the disk blade 12 and the rotating scraper blade 40. Therefore, the rotating scraper system 10 of the present invention provides an efficient way of maintaining a soil-free disk blade 12 while preventing debris from collecting between the disk 12 and the rotating blade 40.

Although the present invention has been described with reference to preferred embodiments, workers skilled in the art will recognize that changes may be made in form and detail without departing from the spirit and scope of the invention.

What is claimed is:

1. A scraper for mounting to a tool bar of a farm implement having rotating disk for tilling soil, the scraper comprising:
a support mounted to the tool bar;
a shaft extending from the support and having a central axis; and
a scraper blade rotatably attached to the shaft and wherein the scraper blade comprises a perimeter and wherein the perimeter of the scraper blade rotatably engages a side surface of the rotating disk to prevent soil from accumulating on the side surface and prevents debris from accumulating between the side surface and the scraper blade.

2. The scraper of claim 1 and wherein the scraper blade moves laterally along the central axis of the shaft.

3. The scraper of claim 2 and further comprising a compression spring positioned between the shaft and the scraper and wherein the compression spring biases the scraper blade into contact with the side surface of the rotating disk.

4. The scraper of claim 1 and wherein the scraper blade comprises a circular perimeter and wherein the scraper blade rotates clockwise or counterclockwise in the path of least resistance when contacting the rotating disk.

5. The scraper of claim 1 and wherein the shaft comprises:
a housing having a through bore along the central axis; and
a bolt extending through the through bore and having a threaded end.

6. The scraper of claim 5 and further comprising a hub attached to the scraper blade and having a stub shaft attached thereto and wherein the stub shaft comprises a threaded bore and wherein the threaded end of the bolt threadably engages the threaded bore to retain the scraper blade to the shaft.

7. The scraper of claim 5 and wherein the scraper blade is removably attached to the hub.

8. The scraper of claim 5 and further comprising a sleeve positioned with the through bore between the bolt and the housing.

9. The scraper of claim 1 and wherein the support comprises:
a mounting bracket attached to the tool bar; and
a shank having a first end and a second end and wherein the first end of the shank is attached to the mounting bracket and wherein the shaft is attached to the mounting bracket proximate the second end thereof.

10. A farm implement comprising:
at least one rotating disk for tilling soil;
a tool bar proximate the at least one rotating disk; and
at least one scraper attached to the tool bar, the scraper comprising:
a support mounted to the tool bar;
a shaft extending from the support and having a central axis; and
a scraper blade rotatably attached to the shaft and wherein the scraper blade comprises a perimeter and wherein the perimeter of the scraper blade rotatably engages a side surface of the rotating disk to prevent soil from accumulating on the side surface and to prevent debris from accumulating between the side surface and the scraper blade.

11. The farm implement of claim 10 and wherein the scraper blade of the at least one scraper moves laterally along the central axis of the shaft.

12. The farm implement of claim 11 and wherein the at least one scraper further comprises a compression spring positioned between the shaft and the scraper and wherein the compression spring biases the scraper blade into contact with the side surface of the rotating disk.

13. The farm implement of claim 10 and wherein the scraper blade of the at least one scraper comprises a circular perimeter and wherein the scraper blade rotates clockwise or counterclockwise in the path of least resistance when contacting the rotating disk.

14. The farm implement of claim 10 and wherein the shaft of the at least one scraper comprises:
a housing having a through bore along the central axis; and
a bolt extending through the through bore and having a threaded end.

15. The farm implement of claim 14 and wherein the at least one scraper further comprises a hub attached to the scraper blade and having a stub shaft attached thereto and wherein the stub shaft comprises a threaded bore and wherein the threaded end of the bolt threadably engages the threaded bore to retain the scraper blade to the shaft.

16. The farm implement of claim 15 and wherein the scraper blade is removably attached to the hub.

17. The farm implement of claim 14 and wherein the at least one scraper further comprises a sleeve positioned with the through bore between the bolt and the housing.

18. The farm implement of claim 10 and wherein the support of the at least one scraper comprises:
a mounting bracket attached to the tool bar; and
a shank having a first end and a second end and wherein the first end of the shank is attached to the mounting bracket and wherein the shaft is attached to the mounting bracket proximate the second end thereof.

19. The farm implement of claim 10 and wherein the at least one disk includes a concave side surface.
